(19) United States
(12) Patent Application Publication
(10) Pub. No.: US 2009/0258811 A1
(43) Pub. Date: Oct. 15, 2009

(54) Automatic Dosing System

(75) Inventors: Rudolph Gitzi, Grellingen (CH); Ivan Hübscher, Basel (CH); Karin Kleeli, Neuenhof (CH); Hans Eggenschwiler, Läufelfingen (CH); Hartmut Kilian, Lörrach (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: MIFA AG FRENKEDORF, Frenkendorf (CH)

(21) Appl. No.: 12/443,580

(22) PCT Filed: Oct. 10, 2007
(86) PCT No.: PCT/EP07/08788

§ 371 Date: Mar. 30, 2009

(30) Foreign Application Priority Data
Oct. 11, 2006 (EP) EPO6 9802

(51) Int. Cl. C11D 17/00; C11D 3/37

(52) U.S. Cl. 510/224

(57) ABSTRACT

Described is a solid dishwashing agent for dishwashers that can be placed within the dishwasher once for several washing cycles and that can be automatically dosed according to the actual need. Said solid dishwashing agent in general is in one piece and comprises a carrier and therein incorporated active substances that at least comprise a builder. Said carrier is a solid, water-soluble matrix that is tight against water and humidity, and forms a dishwashing agent that is dimensionally stable at the highest temperature in the storage container during a washing cycle.

### CROSS REFERENCES TO RELATED APPLICATIONS

This application claims the priority of PCT patent application PCT/EP2006/009802, filed 11 Oct. 2006, the disclosure of which is incorporated herein by reference in its entirety.

### TECHNICAL FIELD

The present invention relates to a dishwashing agent for dishwashers, in particular to a solid dosing system, wherein the stability of the active substances, in particular enzymes and the bleaching system, is secured by a specific composition and production method, it further relates to manufacturing processes for such dishwashing agents ant to the use of such dishwashing agents in dishwashers.

### BACKGROUND ART

In common dishwashers the dishwashing agent needed has to be placed in the receptacle prior to each washing cycle. In general, said dishwashing agent is added in a predetermined amount, without taking differently soiled dishes into consideration for the determination of the necessary amount. This has the disadvantage that either such high an amount of dishwashing agent has to be added that the heaviest soiled dishes are cleaned since otherwise the result might be unsatisfactory. Since the dishes etc. often are not so heavily soiled, this results in waste of dishwashing agent and thus is unsatisfactory.

WO92/20774 discloses a two-part chemical concentrate for institutional cleaning environments wherein the two parts may contain components that are incompatible with each other. The disclosed article is suited for single use.

For liquid dishwashing agent compositions automatic dosing systems that dose just the needed amount of dishwashing agent have already been developed. In such systems, water sensitive components can be kept away from water and possibly interacting components can be separated, e.g. in separate compartments. The main disadvantage of such liquid dosing system is that at the time of refilling, in general, part of the former dishwashing agent composition is still in the container and—unless it is first removed—is mixed with the new dishwashing agent composition. If the same composition is used for refilling the container, this has no detrimental effect. However, if another product is used incompatibilities may occur that might not only affect the result of the washing cycle but also be detrimental for the machine itself, for example if deposits are formed on critical parts such as e.g. temperature sensors etc.

It is therefore much desirable to have an automatically dosable solid dishwashing agent that preferably is shaped such that for correct positioning in a container either any remaining dishwashing agent has first to be removed or any remaining dishwashing agent is first dissolved to keep any undesired interaction to a minimum.

### DISCLOSURE OF THE INVENTION

The present invention will be described in more detail below. It is understood that the various embodiments, preferences and ranges as provided/disclosed in this specification may be combined at will. Further, depending of the specific embodiment, selected definitions, embodiments or ranges may not apply.

Hence, it is a general object of the invention to provide a solid dishwashing agent that can be automatically dosed and by which problems of wrong use can be avoided.

Now, in order to implement these and still further objects of the invention, which will become more readily apparent as the description proceeds, the dishwashing agent is manifested by the features that it is in the form of a shaped article large enough to allow more than one washing cycle, it comprises an effective amount of a surfactant which is low-foaming, non-ionic and has a melting point>40° C. Such dishwashing agents are in particular suitable for use in dishwashing machines.

In an advantageous embodiment, the dishwashing agent of the present invention comprises a carrier and therein incorporated active substances, wherein said carrier is a solid, water-soluble matrix that is tight against water and humidity, wherein said dishwashing agent is dimensionally stable at the highest temperature in the storage container during a washing cycle, wherein said wash active substances at least comprise a builder, and wherein said dish washing agent is in the form of a block or bar large enough to allow more than one washing cycle.

One problem with a solid dosable dishwashing agent is the sensitivity of some components, in particular the enzymes and the bleaching system, to water, in particular to water in combination with high temperature during the washing cycle.

In the scope of the present invention it has now been found that it is possible to incorporate humidity sensitive compounds into a matrix that combines the properties of being “tight”, “temperature stable” and “soluble”. The matrix is “tight”, i.e. does not comprise voids or cavities or pores or capillaries etc. through which water might penetrate into the solid dishwashing agent composition. This property may be obtained by a matrix having an open porosity below 25 vol-%, preferably below 20 vol-%. The open porosity is calculated based on the apparent density of the solid (g/cm*; He-pycnometry) and the bulk density (calculated based on weight and volume). This low porosity is in contrast to conventional dishwashing agents which posses a high porosity, typical values are in the range of 40 vol-%, to ensure fast dissolving during the washing cycle. It is also noted that coated tablets for dishwashing are not “tight” in the context of this invention, as such coating aims to improve handling and to ensure fast dissolving. Further, the matrix is “temperature stable”, i.e. said matrix simultaneously has to remain solid at the highest possible temperature to which the dishwashing agent comprising container (storage container or only container) might be subjected, in general up to temperatures of at least about 70 to 80° C. Further, the matrix shows “good solubility properties”, i.e. said matrix must have a good, fast, preferably within 1 to 5 minutes, solubility even in cold water.

It has now been found that a matrix suitable for the purpose of the present invention preferably results in a dishwashing agent that melts close to or above the intended washing temperature. In general, the dishwashing agent melts above about 70° C., preferably above about 75° C., in particular at or above about 80° C., and preferably said matrix also has a turbidity/cloud point of above about 18° C., preferably above 25° C.

Such a matrix is obtainable from polymers selected from the group consisting of polyethylene glycols, polypropylene glycols, methoxypropylene glycols (M-PEGs), block copolymers thereof, or low-foaming non-ionic surfactants with a melting point above 40° C., in particular ethylene oxide (EO)/propylene oxide (PO) adducts, optionally in the presence of one or more further/other solid or liquid surfactants selected from the group of low-foaming non-ionic surfactants such as e.g. one or more fatty alcohol alkoxylates, one or more fatty alcohol ethylene oxide (EO)/propylene oxide (PO) adducts, one or more EO/PO block copolymers, one or more fatty alcohols such as stearyl alcohols, and/or one or more co-builders such as polycarboxylates, e.g. copolymers of acrylic acid and maleic acid.

The average molecular weight of the polymers preferably forming the matrix and the optionally also present surfactants and co-builders each can vary in a broad scope, as long as a matrix is formed that together with the further ingredients results in the desired melting point of the dishwashing agent and preferably also in the desired turbidity. Preferred ranges of the average molecular weights of the preferred polymers, surfactants and preferred optional co-builders are:
polyethylene glycols (MW: 6000-35000 g/mol)
polypropylene glycols (MW: 2000-4000 g/mol)
methoxypropylene glycols (M-PEGs) (MW: 950-5600 g/mol)
EO/PO adducts (e.g. Aduxol®) (MW: 1000-8000 g/mol)
EO/PO block copolymers (e.g. Pluronic®) (MW: 1000-8000 g/mol)
polycarboxylates (MW: about 70000 g/mol)

Incorporated into said matrix are active substances, namely at least one builder, preferably also at least one low foaming non-ionic surfactant and at least one enzyme. The dishwashing agent may also comprise a combination of at least one low-foaming non-ionic surfactant and at least one cationic surfactant and/or at least one amphoteric surfactant. In order to have a very fast effect of the active substances, the size of the particles incorporated into a water soluble matrix preferably is below 500 μm.

In a further embodiment, the present invention relates to the manufacture of a dishwashing agent as disclosed herein. In the production of such a dishwashing agent, in general first the matrix is mixed and then the (further) active substances are added. Dependent on the kind of homogeneity, i.e. homogeneously mixed or active substance(s) rich phases incorporated, different production methods may be preferred such as casting or pressing or (co)extrusion etc.

In a further embodiment, the present invention relates to the use of a surfactant which is lowfoaming, non-ionic and has a melting point>40° C. in a dishwashing agent, in particular in a dishwashing agent as described herein. Until now, such surfactants were considered unsuitable for dishwashing agents, preference was given to such surfactants that are liquid at room temperature, i.e. having a m.p. below 25° C.

In a further embodiment, the invention relates to a dishwashing process using the dishwashing agent as described herein. In conventional processes, the dishwashing agent is placed in a specific compartment of the dishwasher (receptacle) and released to the cleansing water by opening said compartment. Briefly, according to the inventive dishwashing process, the dishwashing agent is also placed in a specific compartment, but this compartment is not opened during the washing cycle, only an eroding medium (e.g. water) is brought into contact with the dishwashing agent to erode/dissolve a predetermined amount of dishwashing agent for use in the dishwashing process. A dishwashing agent of the present invention upon use is placed in a specific container within the dishwasher, said container being preferably such that the eroding medium is brought in contact with only the area of the dishwashing agent to be eroded/dissolved. Although it is possible to design a container such that erosion can take place from the top, the bottom or the side, in view of fast removal of the eroding medium supply from the bottom or the side is much preferred.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows in cross section a dishwashing agent formed as a bar with rectangular footprint and comprising within a matrix homogeneously distributed active substances (not shown since homogeneously distributed and not forming a second phase).

FIG. 2 shows in cross section a dishwashing agent formed as a bar with rectangular footprint and comprising incorporated within a matrix smaller bars (shown with circular basic area) comprising at least part of the active substances in concentrated form.

FIG. 3 shows in cross section a dishwashing agent formed as a bar with rectangular footprint and comprising incorporated within a matrix randomly distributed bead like phases comprising at least part of the active substances in concentrated form.

FIG. 4 schematically shows several possibilities for eroding the dishwashing agent wherein db=detergent bar; ez=erosion zone; ns=nozzle system; s=seal.

FIG. 5 is a flow diagram schematically showing the manufacturing of the inventive dishwashing agent.

### MODES FOR CARRYING OUT THE INVENTION

### Shaped Article

In principle, the shaped article may have any form or size and is determined inter alia by the manufacturing process and by the intended use. Advantageously, the geometric shape of the dishwashing agent is in the form of a block and preferably a bar which is longer than the diameter of its basic area, often much longer to get more accurate dosing and to limit the surface that is in contact with the eroding medium, in general water or an aqueous solution/dispersion.

The base area (also referred to as “basic shape”) can be any geometric shape, however, preferred forms are symmetric forms such as circles, ovals, squares or rectangles. Presently preferred are rectangles.

If a specific positioning within the container (e.g. of a dishwasher) is desired, asymmetric forms might be favorable. The dimension (diameter) of the basic area is chosen dependent of the desired accuracy of the dosing and the dissolving rate. It has been found that for presently preferred compositions said area advantageously is in the range of 500-3500 mm², much preferred about 750 to 2800 mm², most preferred about 1000-2000 mm². These ranges are suitable in order to keep the dosing accuracy in a range of ±15% for e.g. compositions as explicitly described below.

The length of the bar can be adjusted to the estimated dose for each washing cycle and the intended number of washing cycles. The number of washing cycles can be freely selected. As disclosed herein, the dishwashing agent is designed to allow more than one washing cycle in a conventional dishwasher. The preferred number of cycles is around the intended number of cycles within one month, typically at least 10 cycles, preferably about 20 to 30 cycles. For daily use about 30 cycles are typical. Correspondingly, a bar with a basic area of about 1500 mm² has a length of about 250 mm (30 cycles) or 170 mm (20 cycles).

Typically, dishwashers require about 20 g of dishwashing agent of the present invention. The shaped article thus has a typical weight of between 200-1000 g, preferably 400-800 g, much preferably 550-650 g.

Distribution/Homogenity:

The dishwashing agent can be a homogeneously mixed composition or it may comprise compartments/phases with higher concentrations of specific, e.g. especially humidity sensitive, compounds, or compartments/phases wherein compounds that might interact with each other are separated.

Such different phases/compartments lead to an additional protection of active substances from chemical reactions with each other and/or the environmental humidity. Different phases may also assist in an additional control of the dosing of the active substances.

In order to further enhance stability, all or part of the ingredients may be incorporated into the matrix in coated form. In particular enzymes and bleaching agents are preferably incorporated in coated form. They can either be homogeneously mixed with the matrix or incorporated in additionally protected “inner” phases of the dishwashing agent.

The inventive dishwashing agent comprises a matrix 1 and active substances, examples of which are further described below. The active substances can either be homogeneously distributed throughout the matrix 1 or they can be present in separate phases 2 or part of the active substances can be homogeneously mixed with the matrix 1 and part can be present in separate phases 2. Wherein in all embodiments an essentially homogeneous composition over the basic area, i.e. the area that is eroded, has to be ensured.

The matrix 1 essentially consists of a water soluble medium that is dimensionally stable at the temperatures to be expected in dishwashers and water-tight as well as humidity-tight such that it serves as a sealing and protection medium for critical substances. The matrix 1 is preferably formed by polyethylene glycols (PEG) and/or polypropylene glycols (PPG) and/or polyethylene glycol-polypropylene glycol block-copolymers, and/or EO/PO adducts with a melting point above 40° C., optionally and preferably together with further/other surfactants, in particular low-foaming non-ionic surfactants. Much preferred high molecular weight polyethylene glycols and/or polypropylene glycols are used as polymers.

The substances intended to form the matrix 1 are chosen with regard to their average molecular weight and combined such that the mixture, or the final solid dishwashing agent, respectively, has the desired physical properties, in particular the desired water and humidity tightness, dimensional stability and dissolution rate.

By homogeneously incorporating the active substances within the matrix 1 it is ensured that during each washing cycle the same composition of active substances is delivered.

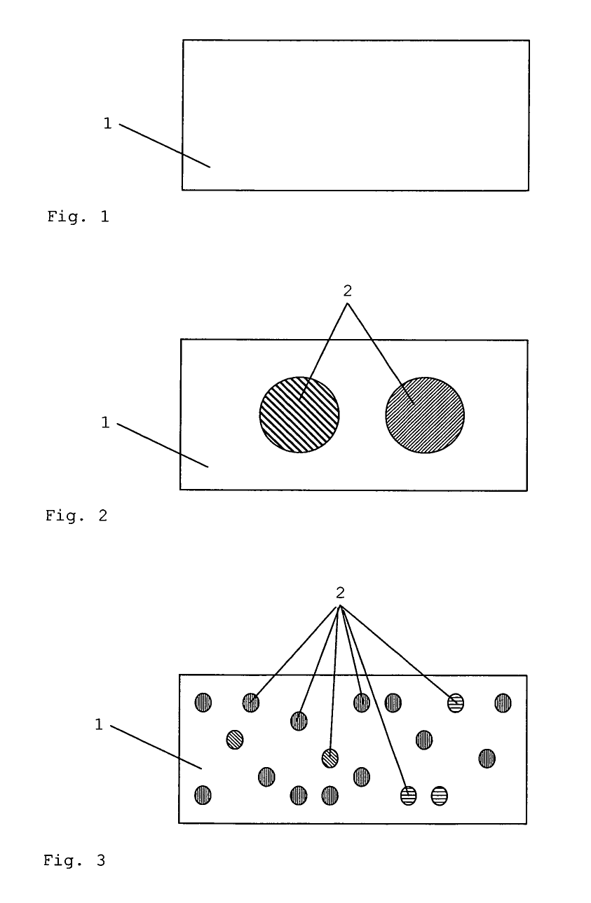

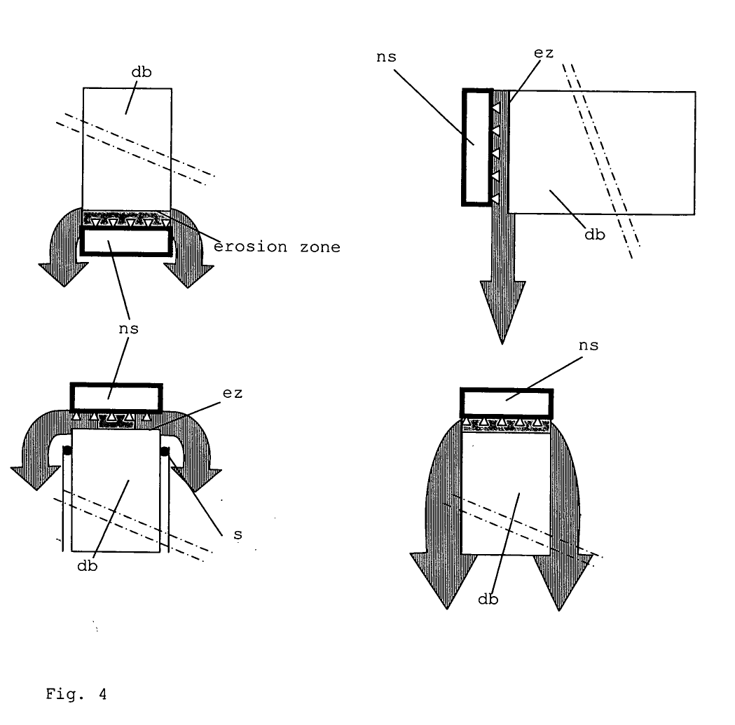

“Homogeneously incorporating” in connection with the dishwashing agent of the present invention does not only mean that all active substances are first homogeneously mixed and then this homogeneous mixture is homogeneously incorporated within the matrix 1. Such procedure would lead to only one of the possible embodiments. As “homogeneously incorporated” also a homogeneous distribution of smaller, e.g. spherical phases 2 separating possibly interacting components is considered (see FIG. 3) or also larger phases 2 such as e.g. small bars incorporated in a matrix 1 forming (together with the incorporated active substance comprising bars) a larger bar or the solid dishwashing agent, respectively (see FIG. 2). Crucial for a homogeneous incorporation is that upon dissolving always about the same composition (ratio of matrix ingredients to each active substance) results. Small deviations up to about 15% can be tolerated without affecting the cleaning result.

In order to have a very fast effect of the active substances, the size of the particles incorporated into a water soluble matrix 1 preferably is below 500 μm.

If a several phase composition is chosen it is not absolutely necessary that the carrier of each phase (phase matrix) is identical. For example an active substance comprising phase 2 might lack a surfactant while the basic matrix 1 might incorporate one. Important, however, is that the dissolution rate of all matrixes is identical since otherwise a faster dissolution, a washing out of the matrix 1 or some phases 2 might occur affecting the intended relation between the components.

In a specific embodiment, wherein a retarded full activity of one or more of the active substances is intended, a finely divided second phase 2 might be provided, said second phase having a phase matrix with lower dissolution rate than the basic matrix 1. In order to nevertheless ensure homogeneous dissolution over the whole area, such second phase must be in beads and said beads must be much smaller in diameter than the average length of the block that is generally dissolved in one washing cycle.

For the dimensional stability, the melting point of the matrix 1 should be such that the maximal temperatures expected in dishwashers, in particular at the site of the storage container (also referred to as storage compartment or dosing unit), do not lead to a deformation of the solid dishwashing agent. In order to be on the safe side, variations and inaccuracies of the temperature regulation, in general assumed to be about +5° C., have to be included in the melting point considerations.

As already shortly addressed above, the positioning of the dosing unit (storage compartment) influences the temperature at the container comprising the solid dishwashing agent and might be taken into consideration for determining the needed melting point. Preferably, however, the maximal temperature expected in proximity to the dosing unit is chosen.

In addition to the desired dimensional stability obtained by adjusting the melting point, also the turbidity/cloud point of the surfactants in water is preferably adjusted, namely to above about 18° C., preferably above 25° C.

Use:

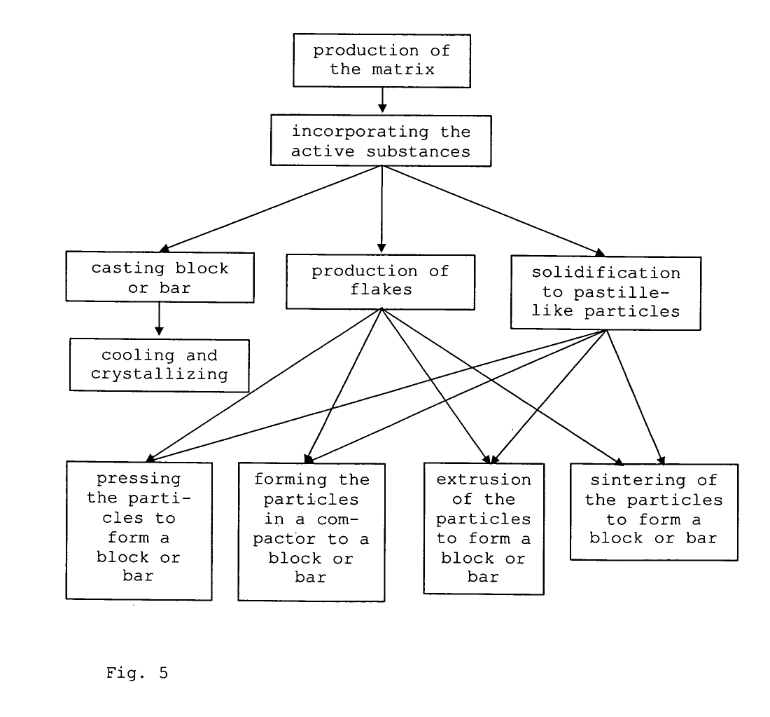

The dissolution of the dishwashing agent is performed by contacting the shaped article (e.g. floating the block or bar) with a liquid eroding medium (e.g. water) under low pressure or without pressure (FIG. 4). This can be done at a predetermined rate for each washing step or, preferably, adapted to the specific need. This adapted dosing can be done by measuring a specific feature of the washing medium formed by dissolved remains of the used, soiled dishes and possibly a basic amount of dishwashing agent. If the feature tells a water supply that the amount of dishwashing agent is insufficient, further water may be supplied to the storage container to dissolve further dishwashing agent. By a continuous surveillance of the washing medium the exactly needed amount of dishwashing agent can be dosed. Suitable features might e.g. be optical features if an optic indicator were present, however, in view of colored left over food a control by means of the conductivity is preferred.

In the case of the presently preferred conductivity measurement, water in a circular flow from the wash liquid or fresh water are floated over the area to be eroded until the desired conductivity (at present 500-100 μS/cm; standardized at 20° C.) is achieved. Then the liquid (water) supply is stopped so that no erosion of the bar takes place any longer. Preferably a bypass is provided that can be opened in order to remove the water from the bar and/or a valve to stop the water supply, respectively.

The positioning of the erosion area must be constructed such that the liquid flows away from the bar and into the base compartment of the machine (see FIG. 4). It is possible to construct the storage container such that the erosion area is floated from the top, the side or the bottom. In view of a fast removal of the water floating from the side or the bottom is much preferred. Especially preferred is floating from the bottom.

The geometry of the floating nozzle(s) has to be constructed such that no voids, cavities, channels etc. are formed due to inhomogeneous pressure of the floated water, or that no undesired water penetration into the dosing system, in particular the container, may occur due to remaining water, that might penetrate into the dosing system by continuously dissolving and depositing part of the dosing system due to the temperature cycles involved in the washing process.

In general, the variability of the conductivity measured at the beginning of each washing step and the actual contamination, allows to define the needed dose for the respective washing step. Preferably this variability is ensured through the internal control of the machine and the selection of the program.

Presently preferred parameters and examples for presently preferred ingredients/components (surfactants, builders, bleaching agents, enzymes, corrosion inhibitors, perfumes colorants) are described in further detail below.

An improved dishwashing agent is obtained if it comprises at least one corrosion protecting agent, e.g. a silver protecting agent, and/or at least one bleaching agent. This improves efficiency of the product.

An improved dishwashing agent is obtained if it comprises at least one perfume and/or coloring agent. This improves the acceptance of the consumer and/or improves safety of the product.

Matrix:

The matrix in general has a melting point in the range of 45-85° C., dependent on the positioning of the storage container and the further (high melting) ingredients. If the bar shall be applicable independent of an actual construction, a melting point of about 80° C. is preferred. The turbidity/cloud point in water should be above 18° C., preferably above 25° C.

Main ingredients of the matrix are consistency providing agents, in particular
one or more polymers selected from the group consisting of polyethylene glycols, polypropylene glycols, methoxypropylene glycols (M-PEGs), block copolymers thereof, and/or one or more low-foaming, non-ionic surfactants with a melting point>40° C., in particular EO/PO adducts, all, the polymers and the surfactants, with different molecular weights ranging from 200 to 40000 as well as mixtures thereof and mixtures of polymers with different molecular weights, and optionally
one or more further/other surfactants selected from low-foaming non-ionic surfactants such as e.g. one or more fatty alcohol alkoxylates, one or more fatty alcohol ethylene oxide (EO)/propylene oxide (PO) adducts, one or more EO/PO block copolymers, one or more fatty alcohols such as stearyl alcohols (e.g. Lorol C18™, obtainable from Cognis), and/or optionally
one or more co-builders such as polycarboxylates, e.g. copolymers of acrylic acid and maleic acid with molecular weights up to 70000.

Preferred main ingredients of the matrix are polymers from the group of polyethylene glycols.

Further preferred main ingredients of the matrix are fatty alcohol alkoxylates, one or more fatty alcohol ethylene oxide (EO)/propylene oxide (PO) adducts.

Such ingredients and mixtures thereof are suitable to adjust the melting point.

Surfactants:

In general all low-foaming non-ionic surfactants and cationic and/or amphoteric surfactants or polymers, respectively that can be combined with the low-foaming non-ionic surfactants can be used. Cationic and/or amphoteric surfactants or polymers, respectively, can be added in order to get specific cleaning effects on the goods to be washed. It was found that a total surfactant content of the inventive dishwashing composition between 5-20 wt-%, preferably between 8-20 wt-% ensures positive results. The surfactants as described herein, in particular the low-foaming, non-ionic surfactants with a melting point>40° C. may be part of the matrix 1 and optionally be present in the second phase 2.

Suitable examples of surfactants in the context of the present invention include:

Low-Foaming, Non-Ionic Surfactants with a Melting Point>40° C.:
low-foaming esters of carboxylic acids, in particular EO/PO adducts
fatty alcohols EO/PO adducts (e.g. Aduxol®)

### Further/Other Non-Ionic Surfactants:

alkyl polyglycol ethers
   fatty alcohol polyglycol ether with 3-25 ethoxy units (EO), e.g. Dehypon E124™ (obtainable from Cognis)
   oxoalcohol polyglycolether
mixed alkyl/aryl polyglycolethers
low-foaming alkyl polyglucosides (APGs)
fatty alcohols, such as stearyl alcohols (e.g. Lorol C18™)
   Further/Other Non-Ionic Polymeric Ethoxylate and/or ProPoxylate (EO/PO) Adduct Surfactants:
alcohol EO/PO adducts
   fatty alcohol EO/PO adducts
   oxo alcohol EO/PO adducts
EO/PO block-copolymers
ethylene diamine ethylene oxide-propylene oxide (EO/PO) block-copolymers
endcapped (fatty) alcohol EO adducts and EO/PO adducts (e.g. butyl endcapped)
low-foaming esters of carboxylic acids, in particular EO/PO adducts

Especially preferred are alkoxylated fatty alcohols, in particular those that are ethoxylated and/or propoxylated. Also especially preferred are EO/POblockpolymers, endgroup capped (fatty) alcohol EO adducts, low foaming esters of carboxylic acids, in particular EO/PO adducts, and mixtures thereof. The used non-ionic surfactants in general have a turbidity/clouding point in the range of 18-65° C.

### Cationic Surfactants or Polymers:

Dialkyldimethylammonium chlorides such as e.g. distearyldimethylammonium chloride, bis(partially hydrogenated nortalow carboxyethyl)-(2-hydroxyethyl)-methyl ammonium methosulfate and diquarternary polydimethylsiloxans.

### Amphoteric Surfactants or Polymers:

caprylic glycinate, cocamidopropylbetain and disodium cocoampho diacetate.

Builders:

Suitable builders are inorganic builders, optionally together with one or more co-builder (“builder systems”), and organic builders. Suitable examples of builders in the context of the present invention include:

Inorganic Builders:

Preferred inorganic builders are selected from the group consisting of zeolites, silicates, phosphates, alkali carriers and mixtures thereof.

Examples of preferred zeolites are zeolite A and zeolite P.

Examples of preferred silicates are alkaline metal silicates, in particular sodium silikates, sodium disilikates, sodium metasilicates, and mixtures thereof.

Examples of preferred phosphates are alkaline metal phosphates, especially preferred pentasodium triphosphate, pentapotassium triphosphate (sodium tripolyphosphate or potassium tripolyphosphate) and mixtures thereof.

Examples of preferred alkali carriers are alkaline metal hydroxides, alkaline metal carbonates, alkaline metal bicarbonates (alkaline metal hydrogencarbonates), alkaline metal silicate, alkaline metal metasilicate and layered silicates and mixtures thereof.

Builder Systems (Comprising Inorganic Builder(s) and Organic Co-Builder(s)):

Inorganic Builders:

A preferred inorganic builder system for use together with an organic co-builder or a system of organic co-builders comprises at least one of the compounds listed below, preferably a mixture comprising all compounds, namely compounds selected from the group consisting of tripolyphosphates, sodium carbonate, alkaline metal silicates, in particular disilicates, layered silicates and zeolites.

Organic Co-Builders:

Organic co-builders are preferably selected from the group consisting of: homologue polymeric polycarboxylates/polycarboxylic acids and copolymeric polycarboxylates/polycarboxylic acids, polymeric amino dicarboxylic acids, polyacetales, dextrines, phosphonates and mixtures thereof.

Examples for homologue polymeric polycarboxylates are polyacrylic acids, alkaline metal salts of polyacrylic acid, polymethacrylic acids, alkaline metal salts of polymethacrylic acid, and mixtures thereof.

Examples for copolymeric polycarboxylates and copolymeric polycarboxylic acids are the acids or alkaline metal salts of acrylic acid and methacrylic acid, acrylic acid and maleic acid, methacrylic acid and maleic acid, acrylic acid and sulfonic acid, and mixtures thereof.

Examples for polymeric amino dicarboxylic acids preferably are polyaspartic acids, their salts and derivatives.

Examples for phosphonates are hydroxyalkane phosphonates, preferrably 1-hydroxyethane-1,1-diphosphonate (HEDP), and aminoalkane phosphonates, preferrably ethylenediamine tetramethylenephosphonate (EDTMP), diethylenetriamine pentamethylenephosphonate (DTPMP), and mixtures thereof.

The co-builders are preferably present as powders.

Organic Builders:

Suitable organic builders are polycarboxylic acids and their salts, in particular the sodium salts.

Examples for organic builders are citric acid, adipic acid, succinic acid, glutaric acid, malic acid, tartaric acid, maleic acid, fumaric acid, sugar acids, their salts and derivatives, amino carboxylic acids, nitrilo triacetic acid (NTA), methyl glycine diacetate and mixtures thereof.

Bleaching Agents:

Suitable bleaching agents are compounds that in contact with water form hydrogen peroxide. Such compounds are used in combination with bleaching activators and optionally boosters and/or catalysts. Further suitable bleaching agents are inorganic or, preferably, organic bleaching agents, especially peracids.

H₂O₂ Liberating Compounds:

Examples for compounds that in water liberate H₂O₂ are sodium percarbonate, sodium perborate tetrahydrate, sodium perborate monohydrate, peroxypyrophosphates, citrateperhydrates, and mixtures thereof.

Bleaching Activators:

Suitable bleaching activators are compounds comprising one or more N-acyl groups and/or O-acyl groups, such as compounds selected from the groups consisting of anhydrides, esters, imides, acylated imidazoles, oximes and mixtures thereof, preferably compounds selected from the following group of examples:
multiply acylated alkylenediamines, in particular tetraacetylethylenediamine (TAED),
acylated triazine derivatives, in particular 1,5-diacetyl-2,4-dioxohexahydro-1,3,5-triazine (DADHT),
acylated glycole uriles, in particular tetraacetyl glycole urile (TAGU),
N-acylimides, in particular N-nonanoylsuccinimide (NOSI),
acylated phenolsulfonates, in particular n-nonanoyloxy benzenesulfonate, isononanoyloxybenzenesulfonate (n-NOBS bzw. isoNOBS) and mixtures thereof,
anhydrides of carboxylic acids, in particular phthalic acid anhydride,
n-methyl morpholine acetonitrile methylsulfate (MMA)
acylated sugar derivatives, in particular pentaacetylglucose (PAG),
N-acylated lactames, in particular N-benzoylcaprolactame, acetylcaprolactame,
decanoyloxybenzoic acid (DOBA), and
mixtures thereof.

Further possible activators for use in the inventive dishwashing agent are nitrites and so called nitrile quats. Some examples are 4-morpholinecarbonitrile, (cyanomethyl)diethylmethylammoniumtosylate, and mixtures thereof. In addition, combinations of usual bleaching activators can be used. Examples for preferred combinations are: TAED/NOBS etc.

Performance “Boosters”:

Examples for suitable performance “boosters” for activated bleaching systems are imines and imine quats (oxazaridine precursors) such as N-methyl-3,4-dihydroisochinoliniumtosylate.

Catalysts:

Suitable catalysts that may assist in the activation of oxygen are organic metal complexes, in particular complexes with Fe, Mn, Cu or Co as central atom. Specific examples of suitable catalysts are salen complexes and saltren complexes, in particular a tris(2-salicylideneamino)ethylamine manganese (III) saltrene complex obtainable as Tinocat™, from Ciba Speciality Chemicals. Further suitable catalysts are manganese complexes with 1,4,7-trimethyl-1,4,7-triazacyclononane ligands (MnTACN) as described in EP 458397 to Unilever, or pentaamine acetatocobalt (III) nitrate (PAAN) (see U.S. Pat. No. 5,804,542 (1998)).

Organic and Inorganic Bleaching Agents:

Organic bleaching agents, especially peracids:

As an alternative or in addition to the bleaching agents that in contact with water liberate H₂O₂, organic bleaching agents, especially peracids may be added either alone or together with a bleaching activator (Suitable bleaching activators are e.g. those described above for the H₂O₂ liberating bleaching agents). Such organic bleaching agents are:

Organic bleaching agents, in particular bleaching agents selected from the group consisting of diacylperoxides, substituted or unsubstituted arylperoxy acids and their salts, substituted or unsubstituted aliphatic peroxyacids and their salts, peroxydicarboxylic acids and their salts, as well as mixtures of all aforementioned bleaching agents.

As an alternative to the bleaching agents that in contact with water liberate H₂O₂, chlorine liberating bleaching agents and their salts may be used.

Inorganic Bleaching Agents:

As an alternative to the bleaching agents that in contact with water liberate H₂O₂, also inorganic bleaching agents, especially peracids and their salts may be used.

An example for diacylperoxides is dibenzoylperoxide.

Examples for arylperoxy acids and their salts are peroxybenzoic acid and their derivatives comprising one or more substituents in the aromatic ring, in particular substituents selected from alkyl, aryl, Cl, COOH, especially magnesium monoperphthalate.

Examples for aliphatic or substituted aliphatic peroxyacids and their salts are peroxylauric acid, peroxystearic acid, o-carboxybenzamide peroxycapronic acid, N-nonenylamidoperadipic acid, N-nonenylamido persuccinate, much preferred E-phthalimido peroxyhexanoic acid (PAP), and mixtures thereof.

Examples for peroxy dicarboxylic acids and their salts are 1,9-diperoxyazelaic acid, diperoxysebacic acids, diperoxododecanic acid (DPDDA), diperoxyphthalic acids.

Examples for chlorine liberating compounds are heterocyclic N-chloroamides such as trichloroisocyanuric acid, dichloroisocyanuric acid (DICA), their salts and mixtures thereof.

Examples for inorganic peracids and their salts, respectively are peroxomonosulfuric acid, prevailingly as potassium monopersulfate triple salt, also known as (caroic acid).

Examples of preferred bleaching systems are tetraacetylethylenediamine (TAED)/sodium perborate monohydrate and 4-morpholinecarbonitrile/sodium perborate monohydrate.

A much preferred bleaching system comprises an organic peracid, in particular phthalimido peroxohexanoic acid (PAP). The organic peracid preferably is used in form of small particles, in general particles of 200-1000 μm, preferably 300-700 μm. In order to enhance the stability in the matrix, the PAP may be used in coated form.

Enzymes:

Enzymes are used to digest some of the food leftovers on the dishes. Preferred enzymes are hydrolases, in particular hydrolases such as proteases, esterases, lipases, amylases, mannanases and much preferred mixtures of said enzymes. Examples for proteases are Alcalase™, Esperase™, Savinase™, Everlase™, Ovozyme™, Purafect OX™, Properase™. Examples for amylases are Termamyl™, Duramyl™, Purastar OxAm™. An example for lipases is Lipolase™. Much preferred are enzyme mixtures comprising proteases and amylases. The enzymes can be used adsorbed on carriers or embedded into a coating in order to additionally protect them from disintegration. A preferred particle size distribution for the enzymes is 200-1000 μm.

Corrosion Protecting Agents:

In many applications it might be desirable to also have a corrosion protecting agent, in particular a silver protecting agent incorporated. Examples for silver protecting agents are triazoles, such as benzotriazoles, bisbenzotriazoles, aminotriazoles, alkylaminotriazoles, and mixtures thereof. Especially preferred are benzotriazol and/or alkylaminotriazoles. It is also possible and within the scope of the present invention to add zinc salts or organo zinc compounds in order to prevent corrosion of the articles to be cleaned such as dishes, cutlery and glasses.

Perfumes:

Suitable perfumes for dishwashing agents are known in the field and may be used in the context of this invention accordingly. Perfumes may be added as such or adsorbed on or incorporated in a carrier.

Coloring Agents:

Any coloring agent suitable for the use in dishwashers may be used.

Specific ranges and compositions are listed in Table 1 on the next pages

TABLE 1

| | | Range of | Pref. range | Specific compositions [%] | | | | | | | | |
|---|---|---|---|---|---|---|---|---|---|---|---|---|
| Function | Material used | use [%] | of use [%] | 1 | 2 | 3 | 4 | 5 | 6 | 7 | 8 | 9 |
| Matrix | PEG 6000-35000 | 5-60 | 5-30 | 30 | 15 | 10 | | 5 | 10 | 20 | 5 | 15 |
| | PPG | 5-40 | 5-30 | | | 5 | 5 | 5 | 15 | 10 | 5 | 5 |
| | Surfactants* | 5-40 | 5-25 | 5 | 10 | 15 | 25 | 20 | 15 | 10 | 25 | 16.7 |
| Builder | Tripolyphosphate | 5-60 | 10-50 | 35 | 30 | 25 | 30 | 20 | 10 | — | 41 | 28 |
| | Copolymers** | 2-20 | 5-15 | 9 | 9 | 14 | 12 | 10 | 10 | 15 | 9 | 12 |
| | Trisodiumcitrate | | | | | | | | 5 | 5 | | |
| Alcaline | Metasilicate | 1-10 | 4-8 | 5 | 5 | 8 | 8 | 5 | 5 | 5 | 2.7 | 10 |
| compound | | | | | | | | | | | | |
| | Disilicate | 1-25 | 5-20 | | | 8.3 | | | 15 | 19.5 | | |
| | Layered silicate | | | | 10 | | 3.8 | 19.8 | | | | |
| | Soda | | | | 4.1 | | | | | | | |
| | NaOH | 1-5 | 2-3 | | 2 | | | | | | | |
| Bleaching | Na-perborate | 2-20 | 4-10 | 8 | | | | | 4 | | | |
| agent | monohydrate | | | | | | | | | | | |
| | Na-perborate | 2-20 | 5-15 | | 8 | | | | | | | |
| | tetrahydrate | | | | | | | | | | | |
| | PAP | 1-20 | 5-15 | | | 10 | 10 | 10 | 3.4 | 10 | 9 | 10 |
| Bleaching | TAED | 1-10 | 3-6 | 4 | 3 | | | | 2 | | | |
| activator | | | | | | | | | | | | |
| Enzyme | Protease | | | 2.0 | 1.5 | 2.0 | 2.5 | 2.5 | 3.0 | 3.0 | 2 | 2 |
| | Amylase | | | 1.3 | 1.3 | 1.5 | 1.5 | 1.5 | 2.0 | 2.0 | 1 | 1 |
| | Mannanase | | | | 0.5 | | | | | | | |
| Ag prot. | | 0.1-1 | 0.2-0.4 | 0.2 | 0.1 | 0.2 | 0.2 | 0.2 | 0.1 | 0.1 | 0.1 | 0.1 |
| Corr. prot. | | 0.1-5 | 0.2-5 | 0.5 | 0.5 | 1.0 | 2.0 | 1.0 | 0.5 | 0.4 | 0.2 | 0.2 |

In Table 1, the notes and abbreviations mean:
*surfactant = low-foaming EO/PO block copolymers, m.p. > 40° C.
**copolymers = maleic acid/acrylic acid copolymer with molecular weight of about 70000 and acrylic acid/sulfonic acid copolymer with molecular weight of about 12000 (Acusol 588G, obtainable from Rohm & Haas)
Pref. = preferred
Ag prot. = silver protecting agent = 1,2,3-benzotriazol
Corr. prot. = General corrosion protecting agent = zinc acetate

The dishwashing agent of the present invention can easily be prepared using methods known to the skilled person in the art. Dependent on the embodiment to be produced, one or the other method may be preferred (see FIG. 5). For example if all ingredients are homogeneously mixed, the active substances may first be mixed with each other and then incorporated into a molten, also premixed matrix 1. The resulting melt can then be casted. In an alternative method, the melt is solidified in form of flakes or other small particles and then pressed or extruded to get its final form.

If the active substances or part thereof are incorporated in separate phases 2, the optionally part of the active substances comprising matrix 1 melt can be produced as described above and formed into extrudable particles. The further phases 2 are analogeously produced and then the matrix 1 and all the phases 2 are coextruded.

In a last method also particles are formed and then the particles are sintered to such an extent that a water and humidity tight matrix 1 is formed.

In yet another method, not shown in FIG. 5, the matrix is formed into granules, then mixed with the optionally partially or preferably totally coated further ingredients and then pressed, preferably without active heating, such that a block or bar with a water and humidity tight, capillary-free matrix 1 is formed. Such a pressure usually is in the range of 10 to 30 tons, dependent on the size of the block or bar to be formed.

A suitable matrix that can be used for all above described block forming methods is mainly made of e.g. polyethylene glycols, polypropylene glycols, methoxypropylene glycols (M-PEG's), low-foaming, non-ionic surfactants with a melting point of >40° C., and EO/PO block copolymers having different molecular weights and fatty alcohols such as stearyl alcohol (Loriol C18). These matrix forming substances and further ingredients are mixed such that the melting point of the matrix or the block, respectively, is above 75° C. and the turbidity point/cloud point in water is above 25° C.

While there are shown and described presently preferred embodiments of the invention, it is to be distinctly understood that the invention is not limited thereto but may be otherwise variously embodied and practiced within the scope of the following claims.

A dishwashing block of 600 g, 5.4*2.8*25.0 cm is obtained by mixing the components of table 1 and pressing them as follows:

Pressure: 15 t results in 17 vol-% porosity
Pressure: 30 t results in 10-14 vol-% porosity.

1. A dishwashing agent comprising a surfactant, a carrier and therein incorporated active substances, wherein said dishwashing agent is in the form of a shaped article large enough to allow more than one washing cycle;
wherein said dishwashing agent is dimensionally stable at the highest temperature in the storage con-tainer during a washing cycle;
wherein said surfactant is low-foaming, non-ionic and has a melting point>40° C.;
wherein said carrier is a solid, water-soluble matrix (1) that is tight against water and humidity;
wherein said matrix (1) comprises polymers selected from the group consisting of polyethylene glycols, polypropylene glycols, methoxypropylene glycols (M-PEGs), block copolymers thereof and mixtures thereof, and optionally said low-foaming, non-ionic surfactants with a melting point>40° C.;
wherein said active substances at least comprise a builder.

2. The dishwashing agent of claim 1, wherein said highest temperature is in the range of about 70 to 80° C. and said dishwashing agent melts above at least 70° C.

3. The dishwashing agent of claim 1, wherein said matrix (1) has a turbidity/cloud point of above 18° C.

4. The dishwashing agent of claim 1, wherein said dishwashing agent is in the form of a block or bar of 200-1000 g.

5. The dishwashing agent of claim 1, wherein said matrix (1) comprises polymers selected from EO/PO block copolymers.

6. The dishwashing agent of claim 1 having an open porosity below 25 Vol-%.

7. The dishwashing agent of claim 1 wherein said matrix (1) comprises a further/other surfactant.

8. The dishwashing agent of claim 1 wherein said matrix (1) comprises a co-builder.

9. The dishwashing agent of claim 1, wherein said active substances further comprise at least one low foaming non-ionic surfactant.

10. The dishwashing agent of claim 1, wherein said active substances further comprise at least one enzyme.

11. The dishwashing agent of claim 1, wherein said active substances comprise at least one further bleaching agent or bleaching system.

12. The dishwashing agent of claim 11, wherein said bleaching agent or bleaching system is tetraacetylethylenediamine (TAED)/sodium perborate monohydrate.

13. The dishwashing agent of claim 11, wherein said bleaching agent or bleaching system is 4-morpholinecarbonitrile/sodium perborate monohydrate.

14. The dishwashing agent of claim 11, wherein said bleaching agent or bleaching system comprises an organic peracid.

15. The dishwashing agent of claim 14, wherein said bleaching agent or bleaching system is phthalimido peroxohexanoic acid (PAP).

16. The dishwashing agent of claim 1, wherein said active substances comprise at least one further substance selected from the group consisting of corrosion protecting agents, perfumes and coloring agents.

17. The dishwashing agent of claim 1 said agent comprising, in addition to the at least one low-foaming non-ionic surfactant with a melting point>40° C., at least one cationic and/or amphoteric surfactant.

18. The dishwashing agent of claim 1 wherein the active substances are present homogeneously admixed with the matrix (1).

19. The dishwashing agent of claim 1, wherein the active substances are present in at least one separate phase (2).

20. The dishwashing agent of claim 1, wherein part of the active substances are present homogeneously admixed with the matrix (1) and part of the active substances is present in at least one separate phase (2).

21. The dishwashing agent of claim 1, wherein the total surfactant concentration is between 5-25 wt-%.

22. The dishwashing agent of claim 1, wherein the block or bar has a base area of 500-3500 min² and a length of 10 to 75 cm.

23. A method for dosing a dishwashing agent of claim 1, comprising the step of floating over a basic area of said dishwashing agent for a time sufficient to dissolve as much dishwashing agent as needed to meet a predetermined characteristic.

24. The method of claim 23, wherein said floating is done from the bottom or from the side.

25. The method of claim 23, wherein the predetermined characteristic is a selected conductivity in the washing compartment of a dishwasher.

26. The dishwashing agent of claim 7 wherein the further/other surfactant is a surfactant selected from one or more fatty alcohols.

27. The dishwashing agent of claim 8 wherein the co-builder is a polycarboxylate.
